(19) United States
(12) Patent Application Publication
(10) Pub. No.: US 2006/0076436 A1
(43) Pub. Date: Apr. 13, 2006

(54) DEVICE FOR SHOWERING

(76) Inventors: Sam Zhadanov, Brooklyn, NY (US); Eli Zhadanov, Brooklyn, NY (US)

Correspondence Address: Ilya Zborovsky, 6 Schoolhouse Way, Dix Hills, NY, 11746, US

(21) Appl. No.: 10/962,135

(22) Filed: Oct. 12, 2004

(51) Int. Cl. B05B 1/34

(52) U.S. Cl. 239/383

(57) ABSTRACT

A device for showering, comprising a housing, a rotatable massaging element arranged rotatably in the housing and formed so that it is rotatable by water and capable of massaging with simultaneous discharge of water, and a water pulsation generating unit connecting to and rotatable together with the massaging element so that during a discharge of water the water pulsation generating unit provide pulsation of a flow of water which is being discharged.

### BACKGROUND OF THE INVENTION

The present invention relates to devices for showering.

More particularly, it relates to devices for showering which are used in bathrooms and shower cabins for washing and massaging a user's body.

Devices for showering are known in the art. They perform various functions of spraying and pulsation, as well as a combination of these functions. Some devices of this type combine rotation and spraying, as disclosed for example in U.S. Pat. Nos. 4,480,922; 2,678,457; 5,007,127; 5,129,121; and 6,021,539. It is believed that the existing devices can be further improved.

### SUMMARY OF THE INVENTION

It is an object of the present invention to provide a device for showering which is a further improvement of the existing devices.

In keeping with these objects and with others which will become apparent hereinafter, one feature of the present invention resides, briefly stated, in a device for showering which comprises a housing; a rotatable massaging element arranged rotatably in said housing and formed so that it is rotatable by water and capable of massaging with simultaneous discharge of water; and water pulsation generating means connecting to and rotatable together with said massaging element so that during a discharge of water said water pulsation generating means provide pulsation of a flow of water which is being discharged.

When the device for showering is designed in accordance with the present invention, it forms a universal device which simultaneously performs all functions of a conventional showering device and maintains a function of a mechanical massage, in combination with a hydraulical massaging action, with the pulsation generating means rotatable together with the massaging means.

The proposed device is designed to improve the process of water procedures in bathrooms and shower cabins by creating more efficient methods of massaging and cleaning of skin, both in a mechanical and in a hydraulic way.

The device represents a universal showering device which combines various functions with the use of a water pressure for rotation and pulsation, as well as a combination of these functions which favorably act on health of a person. The device from outside looks like a conventional hand shower, which has a housing with an extendable handle, within which there are located mechanisms converting a hydraulic pressure of water into various procedures, including a rotation of massaging instruments. The device has a switch which allows to stop rotation and to use a device as a conventional shower.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a section of side view of a device for showering in accordance with the present invention;

FIG. 2 is a section plan view of the inventive device, with a section along a rotor and a switch;

FIG. 3 is a plan view of a head of the inventive device;

FIG. 4 is a view showing a section of the head with a rotary mechanism.

FIG. 5 is a view showing a longitudinal cross-section of a housing of the device;

FIG. 5a is a view showing a transverse cross-section of the housing taken along the lines B-B;

FIG. 6 is a view showing a longitudinal cross-section of the device in a plane which is perpendicular to a cross-sectional plane of FIG. 5;

FIGS. 7a and 7b are views showing a longitudinal cross-section and an end view of a handle of the inventive device;

FIGS. 8a, 8b and 8c are views showing an extension element of the inventive device, its end view and its transverse cross-section;

FIG. 9 shows a plan view and a side view of a concentric bushing;

FIG. 10 is a view showing an insert of the inventive device;

FIGS. 11a and 11b are a plan view and a cross-section of a cover of the inventive device;

FIG. 12 is a view showing a cross-section of the gear of the inventive device;

FIG. 13 is a view showing a cross-section of an internal gear of the inventive device;

FIGS. 14a and 14b are a plan view and a cross-section of another cover of the inventive device;

FIGS. 15a and 15b are a plan view and a cross-section of a rotor of the inventive device;

FIGS. 16a and 16b are a plan view and a cross-section of a ring of the inventive device;

FIG. 17a is a plan view and FIG. 17b is a cross-section of a water distributing element of the inventive device;

FIGS. 18a and 18b are a plan view and a cross-section of a perforator element of the inventive device;

FIG. 19 is a view showing a part of switching button of the inventive device;

FIG. 20 is a view showing another part of switching button; and

FIG. 21 is a view showing a slider of the inventive device.

### DESCRIPTION OF THE PREFERRED EMBODIMENTS

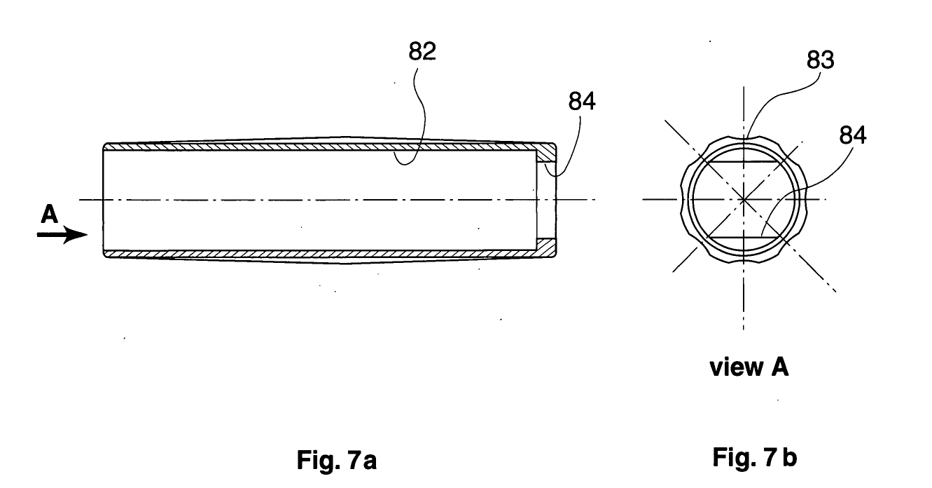

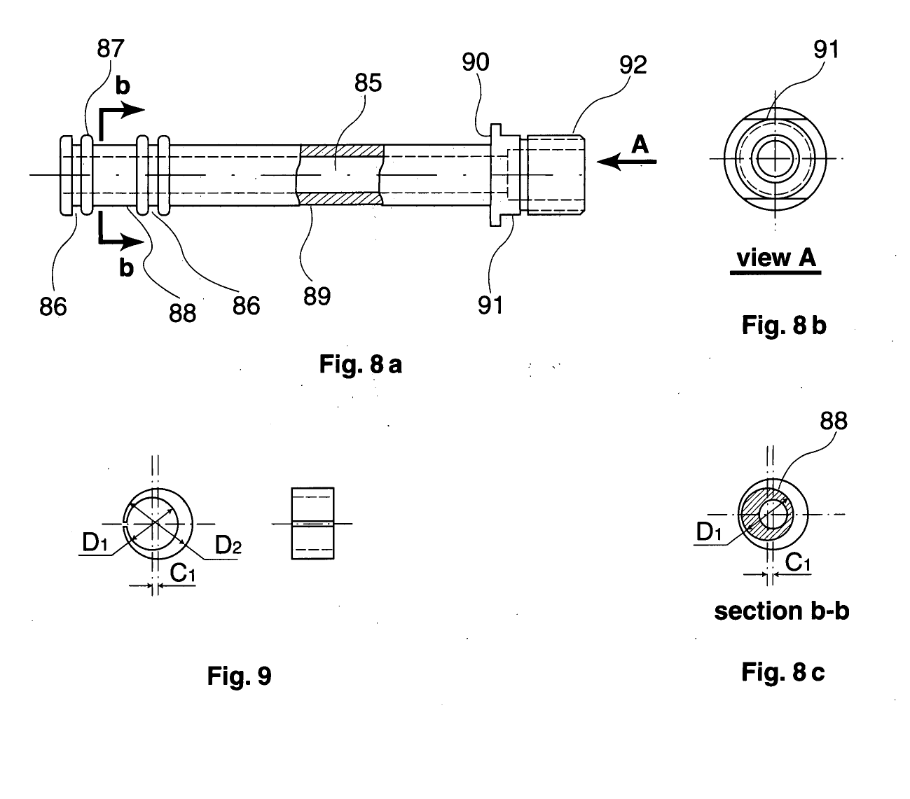

A showering device in accordance with the present invention has a housing which is identified with reference numeral 1 and has a holder 63, on which a handle 2 shown in FIG. 7 can slide. An extension element 3 slides inside the holder 63 as shown in FIG. 8 and has a groove 88 with a split springy insert 5 (FIG. 9) located eccentrically in it. The movement of the extension is limited by inserts 6 shown in FIG. 10, which are located in slots 71 of the housing 1.

The handle 2 is arranged on flats 91 of the extension element 3 and pressed against a flange 90 by a threaded ring 4. The extension has an end provided with a thread 92 for connection with a water supply system. Rubber rings 22 provide sealing of the extension with the housing.

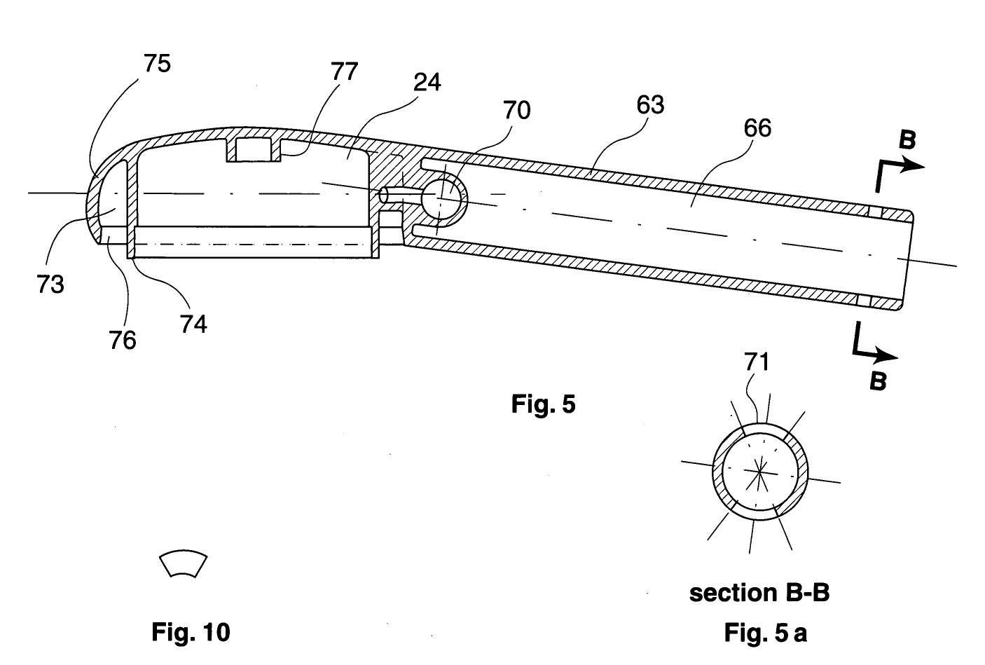

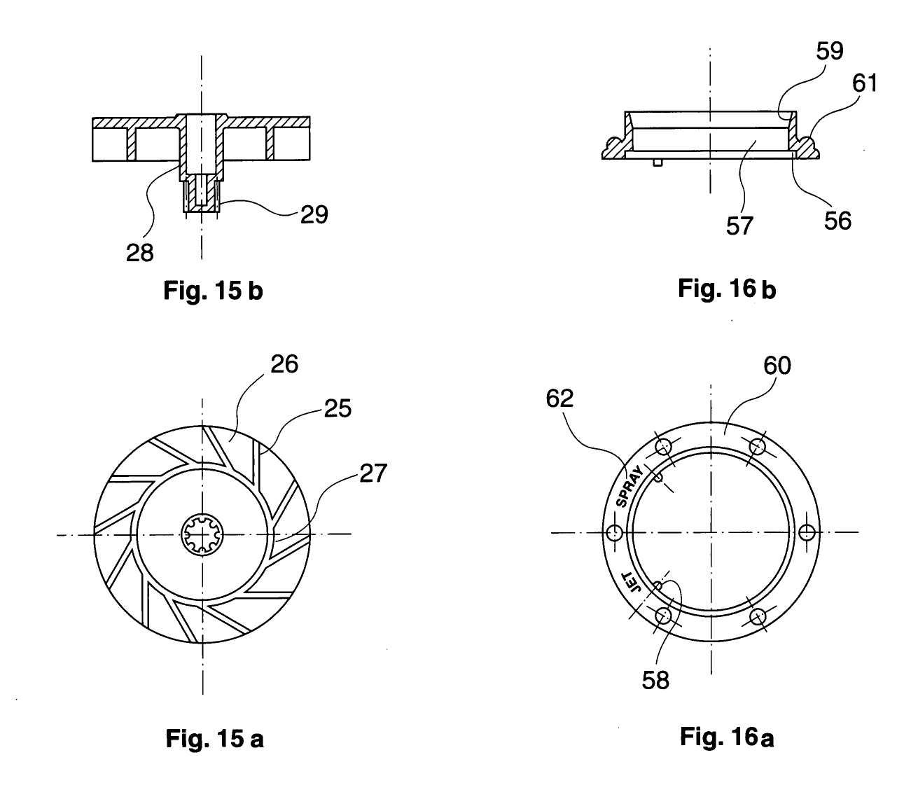

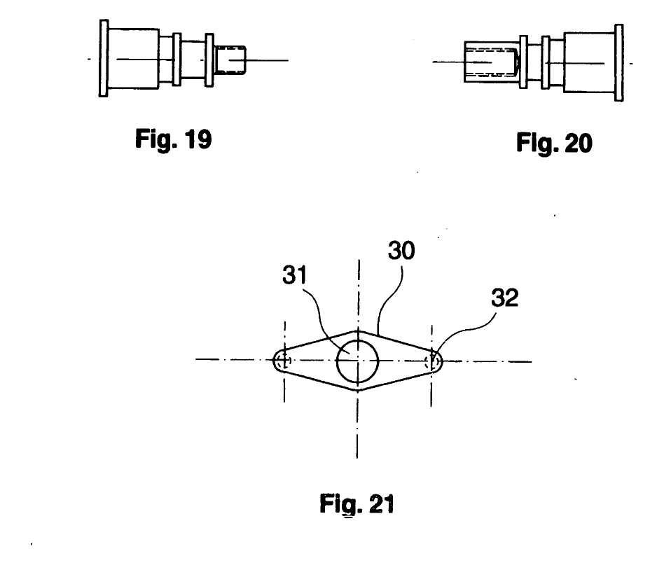

The device has a switching mechanism which includes two buttons 17 and 18 shown in FIGS. 19 and 20, a rubber seal 19 and two sealing rings 20. A rotor 8 shown in FIG. 15 is located in a central cavity 24 of the housing 1 as shown in FIG. 5.

The rotor has inclined vanes 25 located on a disk 26 and connected with one another by a ring-shaped wall 27. An axle 28 is located in the center of the rotor and ends in a pinion 29. A sliding interrupting element 10 shown in FIG. 21 is located on the axle of the rotor and formed as a flat plate 30 with a central opening 31 and side projections 32 which engage with the vanes 25 of the rotor 8.

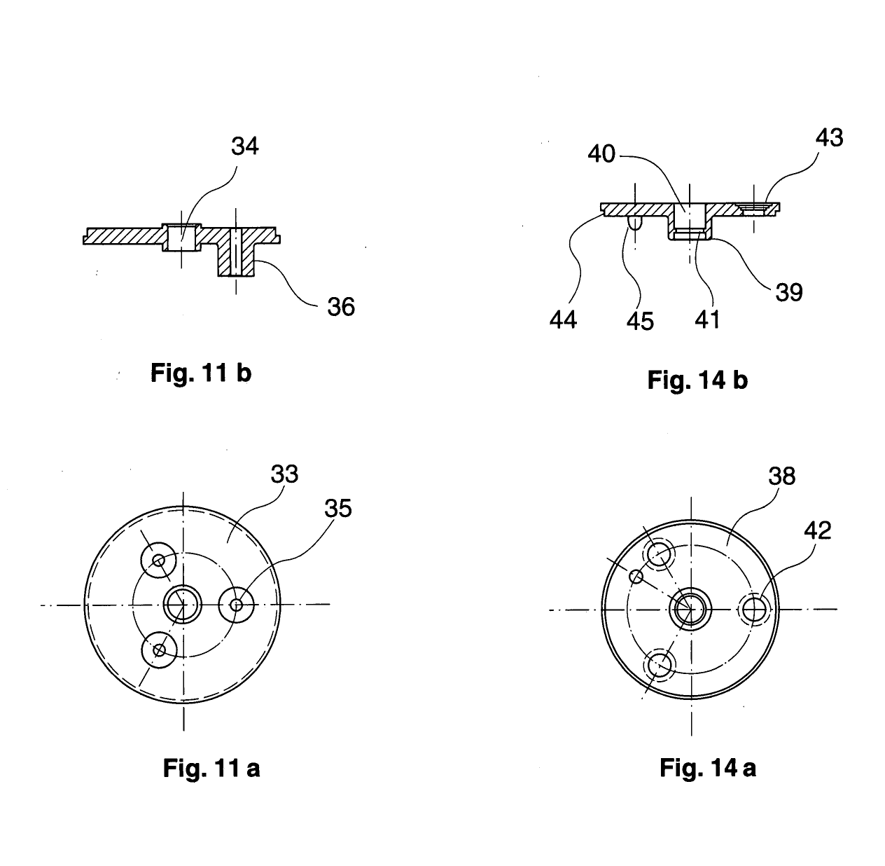

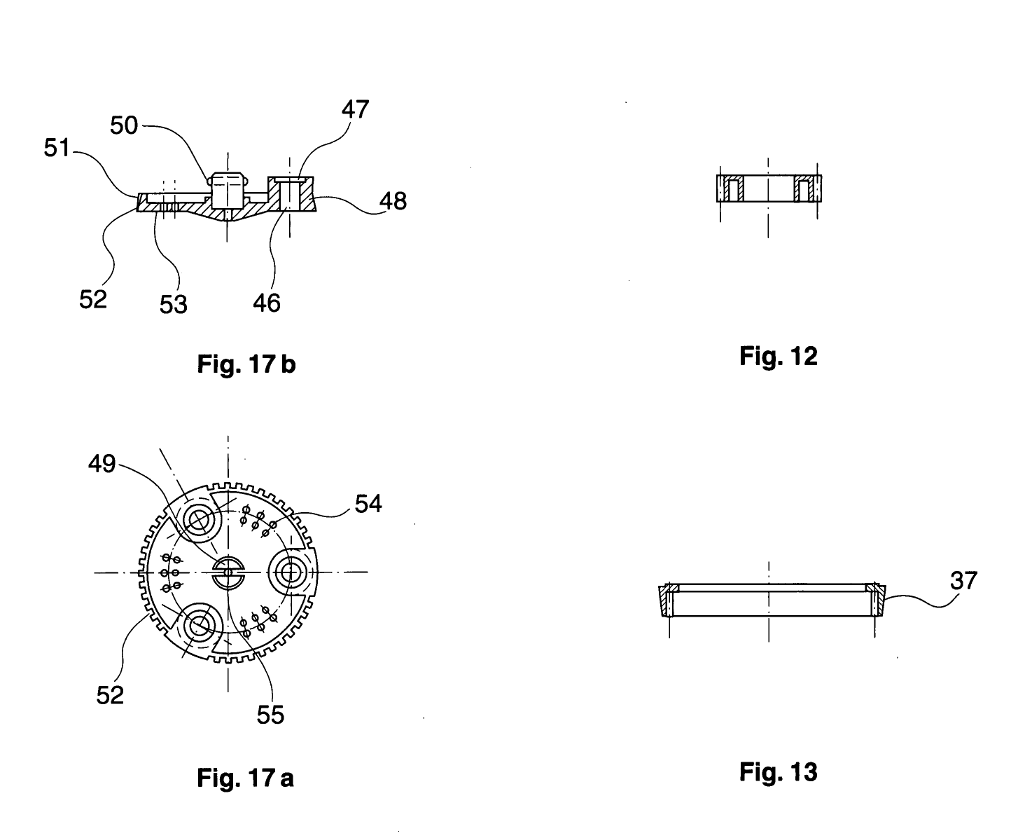

The cavity 24 of the housing 1 is closed by a cover 9 shown in FIG. 11 and formed as a disc 33 with a central opening 34 and three openings 35 located inside axles 36. An axle of the rotor 28 extends through the opening 34 slidingly. Gears 13 shown in FIG. 12 are arranged on the axles 36 and engage with the pinion 29 of the rotor 8 and a gear with internal engagement 14 shown in FIG. 13. Its outer wall 37 has a cone for mounting of working instruments, for example a bristle brush.

The pinions and gears form a planetary transmission operating as a reducer. The planetary transmission is covered from above by a cover 11 shown in FIG. 14 and welded or glued to the axles 36 of the element 9. The cover is formed as a disc 38 shown in FIG. 14 and has a projection 39 with an opening 40 and a ring-shaped lug 39 and a ring projection 41, three openings 42 with a groove 43 for mounting on the axles 36 and a groove 44 on the periphery of the disc, and a stop projection 45.

The water distributing element 12 shown in FIG. 17 has three openings 46 with a groove 47 inside a lug 48. A split lug 49 with a side ring-shaped projection 50 is located in the center of the water distributing element. Conical slots 52 are provided on the periphery, on the conical wall 51. The lower wall 53 has sets of openings 54 and a draining opening 55. O-rings 23 are located in the grooves 47.

The water distributing element 12 is located inside a turnable ring 15 shown in FIG. 16, which has a groove 56 with a sealing ring 21, a central opening 57 with two stops 58 which fix a position of the water distributing element during mounting, along the side walls of the projections 48. The ring has a conical part 59 which, together with the conical wall 51, forms by the conical slots 52 shown in FIG. 17 a jet of a showering flow. The ring has a conical flange 60, spherical projections 61, a technical information 62. The ring forms a driving device during switching of a mode of operation. Fixing of the water distributing element 12 to the cover 9 is performed by snapping of the split lug 49 in the opening 40.

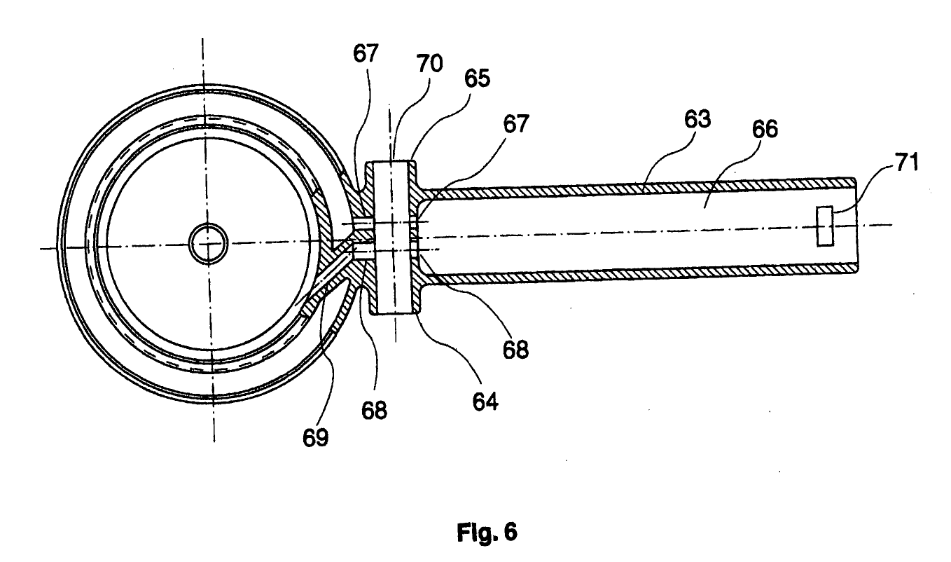

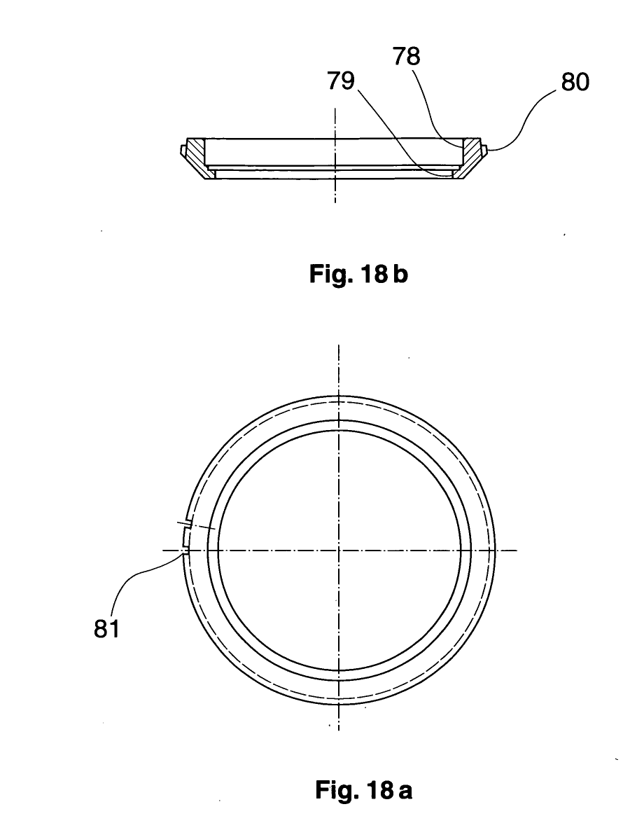

The housing 1 shown in FIGS. 5 and 6 is formed together with the holder 63 as a one piece element, having two hollow projections 64 and 65 and a set of openings including a central opening 66, distributing openings 67, 68, 69, openings of a control system 70, and structural openings 71. The main part of the housing has two receptacles 24 and 73. These receptacles are separated by a cylindrical wall 74. The wall has a conical part 76. The housing in its center has a hub 77. The receptacle 73 is closed by a perforator element 7 shown in FIG. 18. The perforator element is formed as a ring having a cylindrical part 78 with an inner flange 79. The outer wall 80 has an inclination, and grooves 81 which are also arranged with an inclination are provided on it.

The perforator element 7 is welded to the wall 74 of the housing 1 by the flange 79. The combination of the conical grooves 81 with the conical wall 76 of the housing 1 determines a direction of the showering jet.

The handle 2 shown in FIG. 7 is formed as a barrel-shaped cylinder with an inner opening 82, outer slots 83, and inner truncated hubs 84.

The extension element 3 shown in FIG. 8 is hollow and has a throughgoing opening 85, two grooves 86 which are limited by ring-shaped projections 87. A cylindrical portion 84 is eccentrically arranged in the gaps between them and identified in a cross-section BB as D1 with an eccentricity C1. It further has a cylindrical part 89, a flange 90 with truncated planes 91, and it ends in a threaded pipe 92.

The device is connected to a water supply system by the threaded pipe 92. Water via the opening 85 is supplied through the switching mechanism and the openings 67, 68, 69, and through these openings is supplied into one of the receptacles 24 or 73, depending on the position of the switching button 17-18 and a seal 19 which overlaps one of the openings 67 or 68. When the opening 67 is opened, water is supplied into the receptacle 73, and through the opening 81 exits as a showering flow. When the opening 68 is opened, water under pressure is supplied through the opening 69 to the vanes of the rotor 8 and rotates the rotor. The element 10 is also rotated together with the rotor, and water in this case exits through three openings 35 located in the cover 9 as shown in FIG. 11, while the rotatable element 10 alternatingly closes the water flow through these openings so as to generate a pulsating effect. Water flows through the water distributor 12, and depending on a selected position, exits as a pulsing jet or a spray. This position is set by a user by turning of the ring 15 and together with it, of the water distributor 12. The rotating rotor through the planetary reducer, transmits rotation to the working instrument.

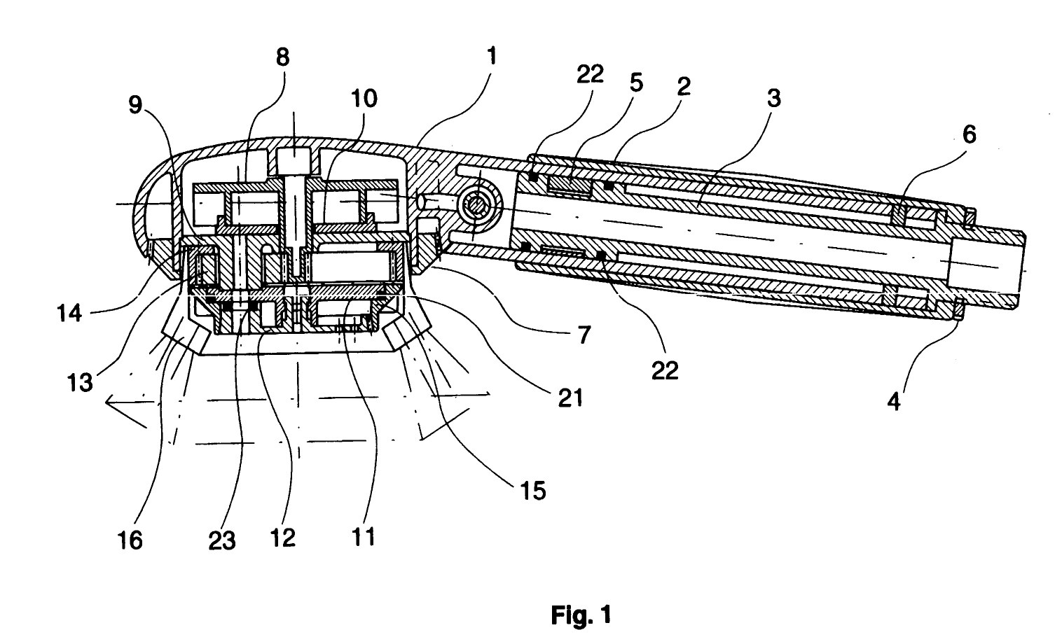

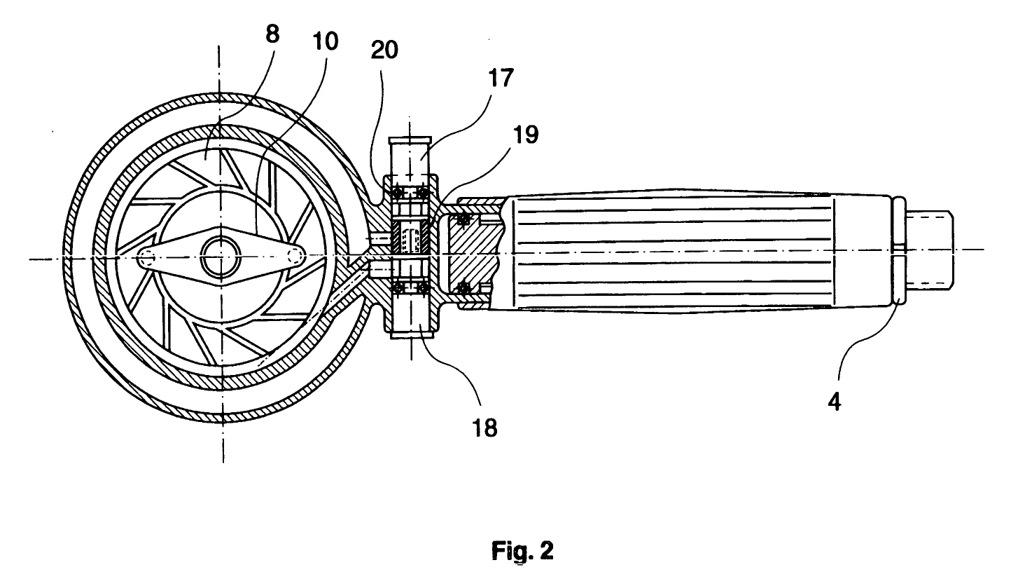

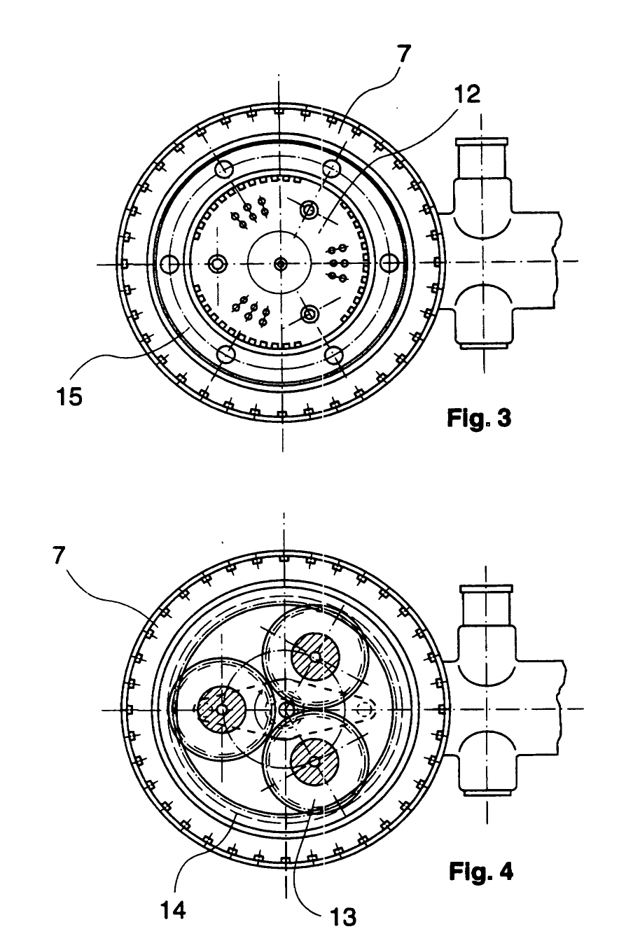

A telescopic mechanism operates by turning of the handle 2, and also together with it by turning of the extension 3 in the opening 66 of the holder 63. During this process the eccentric portion 88 rotates inside the eccentric insert 5 located in the opening 66, and presses or releases the mounting, so as to fix a corresponding position of the extension element. During fixing of the extension element the outer surface of the holder 63 is pressed against the inner surface of the opening 82 of the handle 2 in the zone of the eccentric insert 5 as shown in FIG. 1 by the insert to create an additional friction. Thereby, a two sided fixation is obtained, in particular by interaction between the insert 5 and the inner surface of the holder 63 and also by interaction between the outer surface of the holder 63 and the inner surface of the handle 2.

In the present invention therefore the telescopic handle is actually composed of three elements, namely the outer handle 2, the extension element 3, and the intermediate element or the holder 63. The inner and outer elements 2, 3 are fixed to one another by the threaded ring 4 and interact with one another through the flat surfaces 84, 91, and therefore they are movable together in an axial direction and turnable together in a circumferential direction. The inserts 6 which are embedded in the intermediate element 63 allow the turning of the elements 2, 3, relative to the element 63, and at the same time form a stop when the structure composed of the elements 2, 3 is axially displaced to the right most position. It is also important that the insert 5 is located between two seals 22 to be reliably sealed from water.

It will be understood that each of the elements described above, or two or more together, may also find a useful application in other types of constructions differing from the types described above.

While the invention has been illustrated and described as embodied in device for showering, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for showering, comprising a housing; a rotatable massaging element arranged rotatably in said housing and extending outwardly of said housing and formed so that it is rotatable by water and capable of massaging with simultaneous discharge of water; and water pulsation generating means connecting to and rotatable together with said massaging element so that said massaging-element provides a massage work and simultaneously said water pulsation generating means provide pulsation of a flow of water which is being discharged, wherein said massaging element includes a working part and a rotor part connected with said working part for joint rotation therewith and acted on by water so that said rotor part rotates under the action of water.

2. (canceled)

3. A device as defined in claim 2, wherein said water pulsation generating element is formed as a rotating element which is connected with said rotor part of said massaging element for joint rotation therewith and during a rotation of said element periodically interrupts a flow of water so as to impart pulsation to the flow of water.

4-6. (canceled)

7. A device for showering, comprising a housing; a rotatable massaging element arranged rotatably in said housing and extending outwardly of said housing and formed so that it is rotatable by water and capable of massaging with simultaneous discharge of water; and a tubular extension element forming a water supply portion and displaceable in said housing so as to form a hand-held portion which is extendable; a handle associated with said tubular element and cooperating with said tubular element so that when said tubular element is extended and turned said tubular element is fixed in a corresponding extended position.

8. A device as defined in claim 7, wherein said tubular element has an eccentric portion cooperating with an eccentric formation provided in said housing for fixing said tubular element in said extended position.

9. A device as defined in claim 7; and further comprising stop means which limit a displacement of said tubular element.

10. A device as defined in claim 7, wherein said housing has a holder extending therefrom and located between said tubular extension element and said handle.

11. A device as defined in claim 8; and further comprising two seals, said eccentric portion and said eccentric formation being located between said seals to prevent penetration of water to said eccentric portion and said eccentric formation.

12. A device as defined in claim 10, wherein said tubular extension element and said handle are connected with one another so that they are jointly displaceable in an axial direction and jointly turnable around an axis.

13. A device as defined in claim 9, wherein said tubular extension element has a portion which faces said housing and has a greater diameter than a remaining portion, so that when said portion abuts against said stop means a complete withdrawal of said handle and said tubular extension element is prevented.

14. A device as defined in claim 13, wherein said stop means include slots extending in a circumferential direction and formed in said holder, and inserts inserted in said slots.

15. A device as defined in claim 14, wherein said inserts are located between said handle and said tubular extension element so that said handle and said tubular extension element can slide in an axial direction and rotate in a circular direction relative to said inserts in contact with the later.

16. A device for showering, comprising a housing; a rotatable massaging element arranged rotatably in said housing and extending outwardly of said housing and formed so that it is rotatable by water and capable of massaging with simultaneous discharge of water, wherein said housing has an elongated hollow holder; and further comprising an extension element displaceable inside said holder; a turnable handle arranged on said holder; and an eccentric insert which, for fixing of said extension element in a predetermined extended position, is pressed against an inner surface of said holder and also presses an outer surface of said holder against and on an inner surface of said handle.

17. (canceled)

18. A device as defined in claim 1, wherein said massaging element is formed as a brush.

19. A device as defined in claim 1, wherein said water pulsation generating means and said massaging element are formed so that the flow of water which is being discharged and is pulsated flows through said massaging element.
